(19) United States
(12) Patent Application Publication
(10) Pub. No.: US 2023/0367694 A1
(43) Pub. Date: Nov. 16, 2023

(54) METHOD AND SYSTEM OF ANALYZING AND VISUALIZING TELEMETRY DATA

(71) Applicant: Microsoft Technology Licensing, LLC, Redmond, WA (US)

(72) Inventor: Dmitry Valentinovich KHOLODKOV, Sammamish, WA (US)

(73) Assignee: Microsoft Technology Licensing, LLC, Redmond, WA (US)

(21) Appl. No.: 17/741,902

(22) Filed: May 11, 2022

(51) Int. Cl. G06F 11/36; G06T 11/20

(52) U.S. Cl. CPC G06F 11/3608; G06T 11/206

(57) ABSTRACT

A system and method for generating a visualization graph for telemetry data includes processing a telemetry data log to remove one or more superfluous terms from the telemetry data log, identifying pairs of terms in the telemetry data log that appear within a given vicinity of each other in the telemetry data log, and for a plurality of the identified pairs of terms, calculating a number of times the pairs of terms appear within the given vicinity of each other in the telemetry data log. Once the number is calculated, a visualization graph for the telemetry data log is generated that visualizes at least some of the plurality of the identified pairs by displaying a strength of connection between the at least some of the plurality of the identified pairs.

### BACKGROUND

In order to optimize performance of various programs, software developers traditionally seek to find and remove sources of problems and failures of a software product during product testing and after product release. For example, software can include error reporting services that are configured to allow information regarding various software problems to be collected and communicated to software developers. When a failure or error occurs, the error reporting service can collect information about the error. This information, along with similar error reports from other computers executing the same application, may be sent to a central server, creating a database of failure that can be analyzed to identify software bugs that can be corrected. However, it often takes time and resources for such error reporting services to collect enough data to identify specific errors. Furthermore, collection of such information requires additional computer resources.

Many software venders seek to keep track of operation of software products over time. To achieve this, they continuously collect data about, the operation of the software product while it is being used by customers. Such data may be generated by the software program as it executes. While this data may be helpful in analyzing the operations of the software program, it is often difficult to identify software errors or failures using such data, as the amount of data generated is often too large for processing and/or analysis. For example, processing software telemetry data logs for Internet-scale services may be cost prohibitive, both in bandwidth, as well as processing time. In order to achieve large-scale processing and analysis of software telemetry data logs, more efficient methods are needed to aid in identifying potential new sources of improvement and corrections for the software.

Hence, there is a need for improved systems and methods of processing and analyzing software telemetry data.

### SUMMARY

In one general aspect, the instant disclosure presents a data processing system having a processor and a memory in communication with the processor wherein the memory stores executable instructions that, when executed by the processor, cause the data processing system to perform multiple functions. The function may include processing a telemetry data log to remove one or more superfluous terms from the telemetry data log, identifying pairs of terms in the telemetry data log that appear within a given vicinity of each other in the telemetry data log, and for a plurality of the identified pairs of terms, calculating a number of times the pairs of terms appear within the given vicinity of each other in the telemetry data log. Once the number is calculated, a visualization graph for the telemetry data log is generated that visualizes at least some of the plurality of the identified pairs by displaying a strength of connection between the at least some of the plurality of the identified pairs.

In yet another general aspect, the instant disclosure presents a method for generating a visualization graph for telemetry data. In some implementations, the method includes processing a telemetry data log to remove one or more superfluous terms from the telemetry data log, identifying pairs of terms in the telemetry data log that appear within a given vicinity of each other in the telemetry data log, and for a plurality of the identified pairs of terms, calculating a number of times the pairs of terms appear within the given vicinity of each other in the telemetry data log. Once the number is calculated, a visualization graph for the telemetry data log is generated that visualizes at least some of the plurality of the identified pairs by displaying a strength of connection between the at least some of the plurality of the identified pairs.

In a further general aspect, the instant application describes a non-transitory computer readable medium on which are stored instructions that when executed cause a programmable device to perform functions of processing a telemetry data log to remove one or more superfluous terms from the telemetry data log, identifying pairs of terms in the telemetry data log that appear within a given vicinity of each other in the telemetry data log, and for a plurality of the identified pairs of terms, calculating a number of times the pairs of terms appear within the given vicinity of each other in the telemetry data log. Once the number is calculated, a visualization graph for the telemetry data log is generated that visualizes at least some of the plurality of the identified pairs by displaying a strength of connection between the at least some of the plurality of the identified pairs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example data processing engine for processing and visualizing telemetry data.

FIGS. 3A-3C depict example visualization graphs for visualizing software telemetry data.

FIG. 4 is a flow diagram depicting an example method for generating a visualization graph for telemetry data.

FIG. 5 is a block diagram illustrating an example software architecture, various portions of which may be used in conjunction with various hardware architectures herein described.

FIG. 6 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Telemetry systems capture data associated with a software application (e.g., an Operating Systems, a desktop application, a web-based application, or any other software process being executed by a processor) at runtime when a particular section or line of code has executed. For example, when opening a file in the Microsoft Word® application, a “file open” telemetry event may be emitted. When a menu option is used to copy data, a “data copied” a data copied event may be transmitted. For each application or software instance, there may be different types of telemetry events that are reported, such as, for example, anytime a task is executed, the number of times a user selects (e.g., clicks) an application or icon, time required for an application to respond to a user request, time required for an application to start, usage frequency of particular features of the application, etc., which may provide information or details related to the operation of the application and assist in any analysis. The telemetry data are often transmitted from user client devices to a central location for aggregation and storage. When aggregated, the collected data is used to generate large data logs. Many applications generate textual telemetry data logs based on the collected data. These data logs sometimes include billions or trillions of rows of data that result in log files that are terabytes in size.

Although the telemetry data can be helpful in data-driven problem solving and decision making, analyzing the data becomes overburdening at the large scale at which it is generated. As discussed herein, one of the main difficulties in processing telemetry data is that as the number of customers increase (e.g., hundreds of millions of users for Microsoft Word®), the number of telemetry events also increase. When a user base becomes extremely large, the power, computing cost, and time associated with analyzing the collected telemetry data becomes too extensive and cost prohibitive. For example, it is nearly impossible for humans to review the collected data to identify possible errors or software failures. Furthermore, processing each row of the collected data to detect potential issues is cost prohibitive, both in bandwidth, as well as processing time. As such, there exists a technical problem of lack of efficient mechanisms for processing and analyzing software telemetry data to detect potential problems.

To address these technical problems and more, in an example, this description provides technical solutions for assessment and analysis of telemetry data associated with use of software applications by generating a telemetry data analytical visualization graph which can be used to quickly analyze the telemetry data. This may involve use of a telemetry data processing element that measures the density of terms encountered in the telemetry data as well as the strength of relationships between various terms in the telemetry data. This may be achieved by removing superfluous terms from the data, before mapping the terms in the data log sequentially. In this manner, the number of times a term in the data log is within a given distance (e.g., within 3 words) of another term is calculated. The terms may then be sorted alphabetically and displayed around a radial structure such as an ellipsoidal orbit. Connection between various terms around the radial orbit may be visualized by a visual indicator such as a line connecting the two terms. The strength of the connection may be visualized by a visual indicator such as color. For example, variation of different colors may be used to indicate stronger or weaker connections between the connected terms. This results in a spectral ellipsoid visualization graph that visualizes and summarizes a significantly large number of relationships in extremely large data logs in one graph. The visualization graph may then be used to quickly scan the state of operation of a software application over a given time periods. By comparing such a visualization graph from different time periods, changes that may be indicative of software failures or errors may be quickly identified.

The technical solutions described herein address the technical problem of inefficiencies and difficulties in processing and analyzing large telemetry data sets associated with operations of software applications. The technical solutions provide for use of a telemetry data processing element that calculates density of terms encountered in data logs and strength of relationships between various terms in the data logs over a given time period and visualizes both the density and the strength on an ellipsoidal visualization graph. The technical effects at least include (1) improving the efficiency of the process of analyzing large telemetry data sets; and (2) improving the efficiency of managing software applications by quickly identifying anomalies in the operation of the software application.

As used herein, the terms “telemetry data” and “data log” may be used interchangeably to refer to a collection of data associated with operations of a software application or system. The data may be collected from various computer devices as the software application is being used by users and aggregated to create one or more logs. In some implementations, the data logs are textual logs containing rows of textual data that logs operations of the software program as it is being executed on one or more devices. Furthermore, the term “software component” may be used herein to refer to any suitable type or types of software and may include any suitable set of computer-executable instructions implemented or formatted in any suitable manner. Software components may be implemented as application software, although the techniques described herein are applicable to other types of software components, such as system software (e.g., components of an operating system).

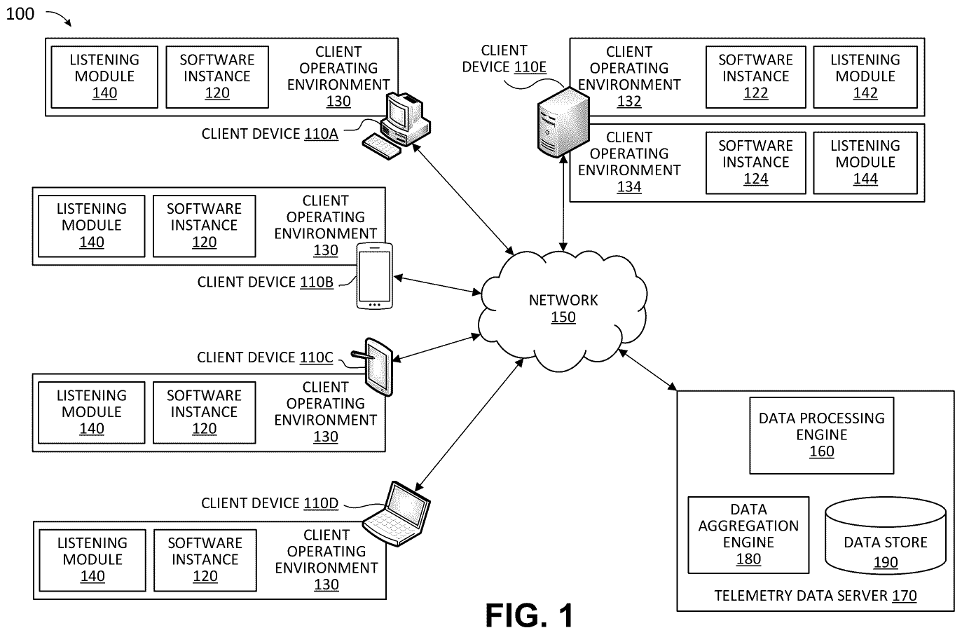

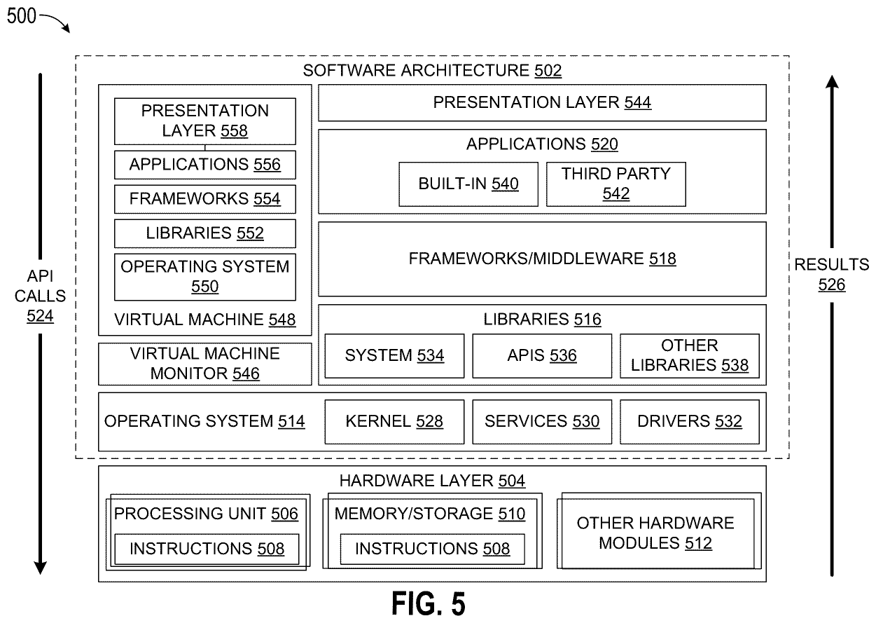

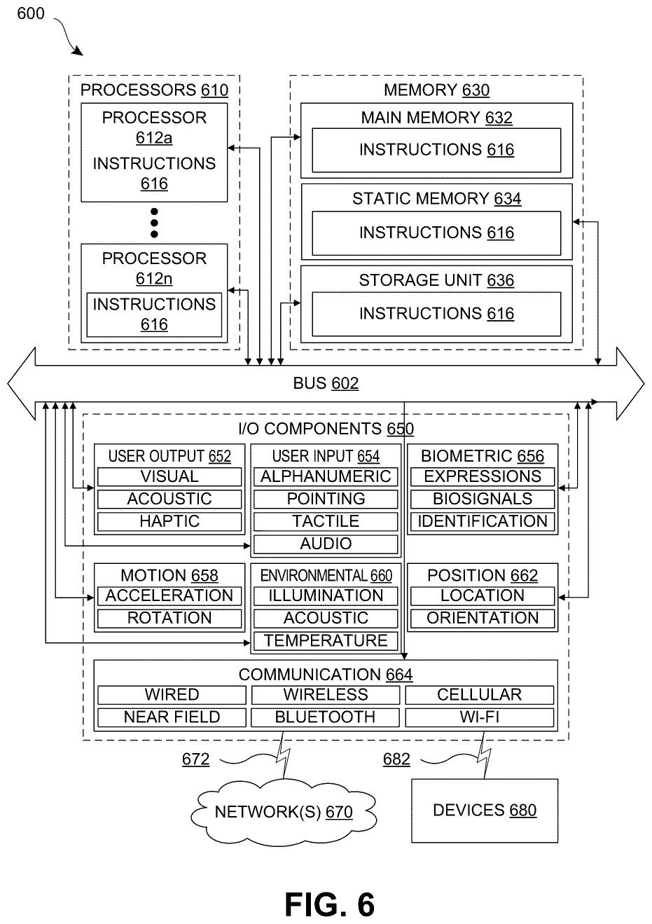

FIG. 1 illustrates an example system 100, upon which aspects of this disclosure may be implemented. The system 100 may include a number of client computing devices 110A-110E, which may also be referred to herein as client devices, client systems, and client information handling devices 110A-110E. In some implementations, one or more of the client devices 110A-110E may, via a listening module 140, communicate with a telemetry data server 170 via a network 150. The client devices 110A-110E may each be any suitable computing device capable of executing computer instructions, such as, but not limited to, a desktop computer 110A, smartphone 110B, a tablet computing device 110C, a notebook computer 110D, and a server computing system 110E. Examples of other types of client devices which may be used include phablets, smart watches, wearable computers, gaming devices/computers, televisions, and the like. The internal hardware structure of a client device is discussed in greater detail in regard to FIGS. 5 and 6.

In the example illustrated, the system 100 includes a single instance of a number of different types of computing devices 110A-110E, each having its own respective performance characteristics. However, it should be understood that this disclosure is not limited in this respect, and the techniques described herein can be used to collect information from a single computer, a set of multiple homogeneous types of computers, and/or non-homogeneous computers having any number of instances that operate individually or in parallel with other instances. It should also be noted that while 5 different computing devices 110A-110E are depicted in the system 100, many more computing devices may exist in systems utilizing the data analysis and processing methods disclosed herein.

In some implementations, the client devices 110A-110E (or collectively client device 110) each have one or more client operating environments 130 in which a software instance 120 of an installed software application is executed by the client device 110. An operating environment 130 may include hardware components of its respective client device 110 and resources (e.g., allocated amounts of partial resources) provided by the client device 110 for execution of the software instance 120, such as, but not limited to, compute (processor type, number of cores or processors, processor frequency, etc.), memory, storage, and network hardware and resources.

The client devices 110A-110E may include virtual or physical computer processors, memories, communication interface(s)/device(s), and the like, which along with other components of the client device 110 are coupled to the network 150 via communication lines for communication with other entities of the system 100. In some implementations, the client devices 110A-110E send and receive data to and from other client devices 110 and/or to the telemetry data server 170 and may further analyze and process the data.

In some implementations, a client device 110 may provide multiple operating environments 130 and/or software instances 120. An example of this is depicted with reference to the server computing system 110E, which includes a first operating environment 132 with a first software instance 122 and a first listening module 142, as well as a second operating environment 134 with a second software instance 124 and a second listening device 144. In some implementations, multiple operating environments operate concurrently, while in other implementations, they operate at different times, but with different configurations. For example, each of the first operating environment 132 and second operating environment 134 may be associated with two different user accounts. In some implementations, first operating environment 132 and second operating environment 134 may be virtualized operating environments, such as but not limited to virtual machines or containers. In some implementations, a single listening module 140 may be used for multiple operating environments 130 of a client device 110.

A listening module 140 may be present in one or more of the client devices 110A-110E. The listening module 140 (i.e., runtime listener) may monitor (e.g., listen to) the code of software instances 120 as it is executed by the processor. Specifically, the listening module 140 may monitor the execution of the code as the software instance is operating, generate telemetry data based on those operations and transmit the telemetry data to the telemetry data server 170 for processing. The listening module 140 may be configured to monitor the operation of and generate telemetry data for multiple software instances (e.g., for different software applications being executed on a client device). In some implementations, each software application (e.g., application instance 120) itself generates the telemetry data as the code is executed. For example, as the application instance 120 is being executed, it may generate data that logs the actions being taken by the software application. In some implementations, the listening module 140 receives this telemetry data generated by the software application, performs some pre-processing operations on the telemetry data (e.g., aggregates the data, and/or removes some unnecessary data, etc.) before transmitting the telemetry data to the telemetry data server 170. In other implementations, the software application 120 itself transmits the telemetry data to the telemetry data server 170. It should be noted that while FIG. 1 depicts locally executed software applications, telemetry data may also be generated and collected for online applications. In such instances, the server executing the online application may include a listening module and/or may make use of the online application instance to generate and transmit telemetry data as the application is executed.

The telemetry data server 170 may be configured to process the received telemetry data to generate telemetry data logs that can be stored in a storage medium for future access and processing. To achieve this, the telemetry data server 170 may make use of a data aggregation engine 180 and a data store 190. The data aggregation engine 180 may receive telemetry data from multiple client devices 110 for one or more software applications. The data aggregation engine 180 may parse the received data based on the type of application for which the data was generated (e.g., data associated with Microsoft Word® applications may be separated from data associated with Microsoft Outlook® applications). Once the data is parsed by application, the data aggregation engine may combine the telemetry data chronologically such that a data log of chronological telemetry data (e.g., event data as multiple application instances of a software application are executed) is generated. The telemetry data may be aggregated over time to periodically generate telemetry data logs for different applications. In an example, a telemetry data log is generated for a given application every 24 hours. The frequency of data log generation and the time period for which telemetry data is aggregated may vary in different configurations. The generated data logs often contain textual data that chronologically logs software commands executed by a software application and as such may contain billions and trillions of rows of data. The generated data logs may be stored in a storage medium such as the data store 190. Although shown as a single data store, the data store 190 may be representative of multiple storage devices and data stores which may be connected to each of the various elements of the system 100. Moreover, while the data store 190 is depicted as being part of the telemetry data server 170, the data may be stored on a separate data server.

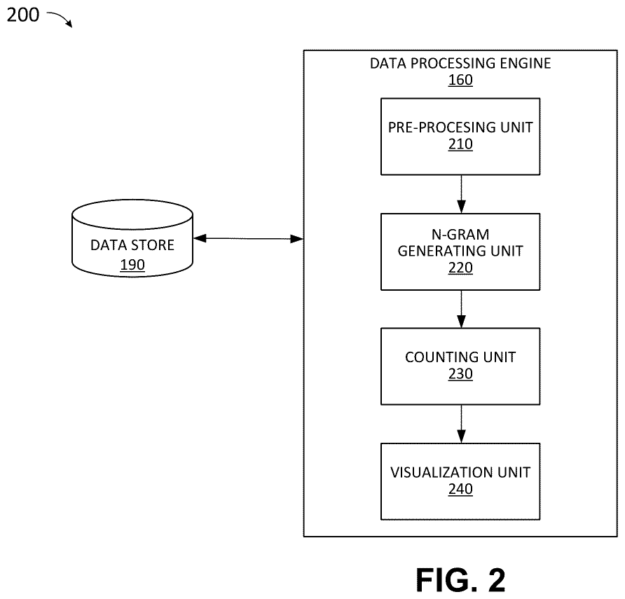

In order to enable analysis of the telemetry data received by the telemetry data server 170, the telemetry data server 170 may make use of a data processing engine 160 for processing and analyzing the telemetry data logs stored in the data store 190. As described in more details with regard to FIG. 2, the data processing engine 160 is configured to perform a machine-based analysis of the telemetry data logs to generate a visualization graph for a given time period. The visualization graph may provide a high-level visualization of the telemetry data on one simplified graph and as such may considerably simplify the process of analyzing the large amount of telemetry data.

The network 150 may be a conventional type, wired, wireless, and/or a combination of wired and wireless network and may have numerous different configurations, including a star configuration, token ring configuration, or other configurations. For example, the network 150 may include one or more local area networks (LAN), wide area networks (WAN) (e.g., the Internet), public networks, private networks, virtual networks, mesh networks, peer-to-peer networks, and/or other interconnected data paths across which multiple devices may communicate. The network 150 may also be coupled to or include portions of a telecommunications network for sending data in a variety of different communication protocols. In some implementations, the network 150 includes Bluetooth® communication networks or a cellular communications network for sending and receiving data including via short messaging service (SMS), multimedia messaging service (MMS), hypertext transfer protocol (HTTP), direct data connection, WAP, email, and the like.

FIG. 2 depicts an example data processing engine for processing and visualizing telemetry data. The data processing engine 160 may include a preprocessing unit 210, an n-gram generating unit 220, a counting unit 230 and a visualization unit 240. One a request for generating a visualization graph for a given time period for telemetry data associated with an application or service is received, the data processing engine 160 may first retrieve the telemetry data log(s) from the data store 190. This may involve submitting a request for a data log that corresponds with the application and time frame for which visualization is requested. Once the appropriate data log(s) is retrieved by the data processing engine 160, the pre-processing unit 210 may first remove terms/characters in the data logs that are not likely to be useful to the analysis. These terms may include stop words (e.g., “a”, “the”, “is”, “are”), prepositions, numbers, non-alphabetic characters (e.g., question marks, exclamation marks and the like) and any other terms or characters that are not likely important to the analysis. Once some or all of the unnecessary terms/characters are purged, the resulting data log may be transmitted to the n-gram generating unit 220 for further processing.

The n-gram generating unit may parse the data log to generate n-grams of terms that are withing a given vicinity from each other in the data log. In some implementations, the n-gram generating unit 220 generates bigrams for each two neighboring terms in the data logs. In this manner, pairs of words that appear next to each other in the data log are identified. In other implementations, where more connections between terms are examined, terms that are within 3, 4 and/or 5 words from each other are also identified. The number of n-grams may depend on the configuration and needs of the system and may be changeable as needed.

Once the neighboring terms (e.g., bigrams) are identified and generated by the n-gram generating unit 220, they may be transmitted to the counting unit 230, which may count the number of times each pair of words is encountered in the data log. For example, if the words “operation” and “failed” are encountered multiple times within a given vicinity of each other (e.g., next to each other), the number of times they appear within that vicinity is counted (e.g., 5000 times). The list of word pairs and the number of times they appear within the given vicinity of each other may then be transmitted to the visualization unit 240.

The visualization unit 240 may create a visualization graph based on the received data that depicts both the density of given terms in the data log and the strength of connections between different terms. This may be achieved by first sorting the received terms alphabetically and then placing the sorted terms alphabetically along a radial structure such as an ellipsoidal diagram. Then each two terms that appear within the given vicinity of each other more than a given number of times (e.g., more than 1,000 times) may be connected with each other using a visual indicator such as a colored line. The number of times two terms need to appear within the given vicinity of each other before they are displayed as being connected on the graph may be changeable based on the desired configuration. In some implementations, the number may be a parameter that can be changed by a user who submits the request for generating the graph. For example, based on the level of detail required, the user may request that only terms that appear more than 10,000 times close to each other be indicated as being connected. The strength of the connection between each two terms may be visualized by a visual indicator such as color. For example, lighter colors may be used to display weaker connections, while darker colors are used to indicate stronger connections (e.g., terms that appear together more often). Other types of visual indicators may also be utilized. For example, different types of lines may be used in different configurations. In some implementations, the thickness of the line connecting each two term may indicate the level of connection between the terms. The generated visualization graph may then be transmitted for display to the client device of the user who submitted the request for visualization.

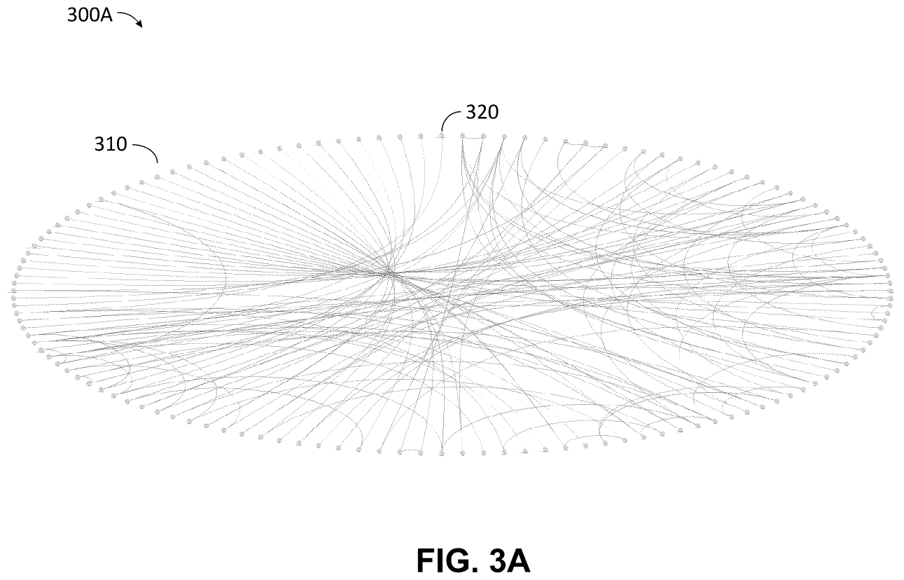

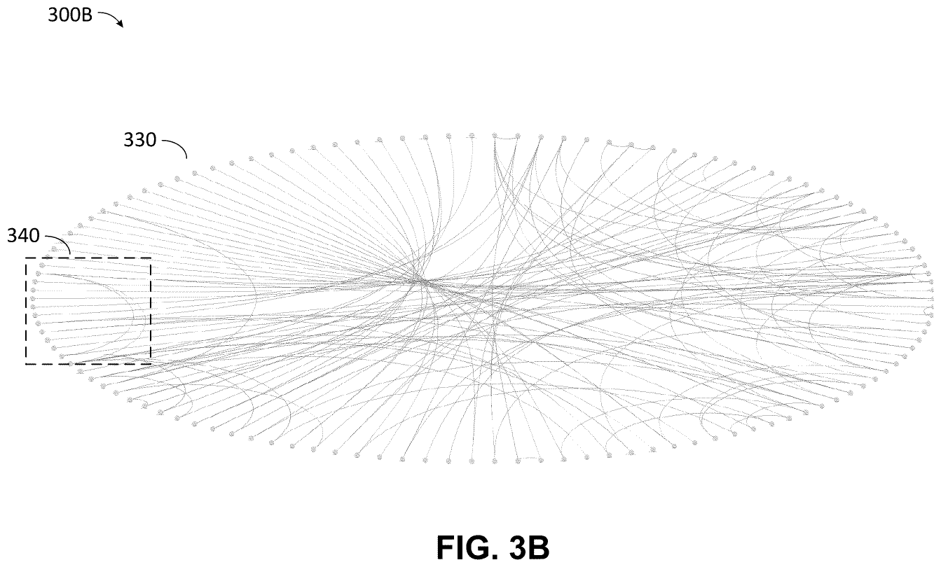

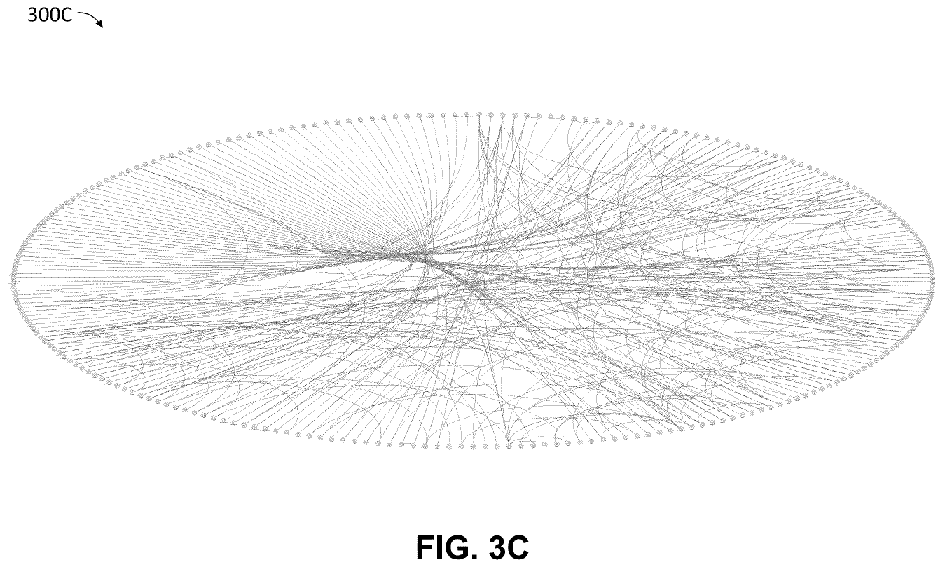

FIGS. 3A-3C depict example visualization graphs for visualizing software telemetry data. FIG. 3A depicts a visualization graph 300A which visualizes an example telemetry data log collected over a 24-hour time period. The visualization graph 300A displays a spectral ellipsoid 310 which visualizes the density and strength of connections between terms identified in the examined telemetry data log. Each of the circles 320 (only one is identified with an element number) around the ellipsoid 310 may represent one of the terms identified in the telemetry data log. For example, the circle 310 may represent the term “adding.” As discussed above, only terms that appear within a given vicinity of (e.g., next to) another term more than a predetermined number of times may be displayed along the ellipsoid 310. The pre-determined number may be a changeable parameter that can be set by a user via a user portal. Alternately and/or additional, a default number may be set by the system. For example, the data analysis system may only display terms that appear next to another term more than 8000 times. The terms may be positioned around the ellipsoid 310 alphabetically. Other configurations are also possible.

In some implementations, the actual terms may be displayed next to the circles 320 that represent them. For example, the term “adding” may be displayed adjacent to the circle 320 on the visualization graph 300A. In another implementation, there may be an option for enabling/disabling display of the actual terms on the visualization graph 300A. In some implementations, the terms may be displayed when a graphical user interface (GUI) zoom-in feature is utilized to zoom into the visualization graph 300A.

Each two circles 320 representing two terms that appear more than the predetermined number of time next to other (or within a given vicinity of each other) may be connected by a line. Thus, the lines in the visualization graph 300A represent connections between the terms. A visual indicator such as color may be used to represent the strength of connections between the terms. For example, color temperature may be used to represent the number of times two terms appear next to each other or within a given vicinity of each other. In an example, different colors are used to represent different range of numbers. For example, terms that appear more than 50,000 times next to each other or within a given vicinity of each other may be connected by a red line, while terms that appear more than 40,000 times next to each other or within a given vicinity of each other may be connected by an orange line. Similarly, a yellow line may be used to connect terms that next to each other or within a given vicinity of each other more than 30,000, and so on. In some implementations, a legend may be displayed next to the ellipsoid 310 to depict the range of numbers represented by each color. In this manner, the visualization graph 300A provides a quick and efficient overview of the state of the telemetry data. A similar visualization graph depicting the same telemetry data for a different time period may then be generated to compare the state of the telemetry data. Changes between visualization graphs for different time periods may then be analyzed and examined to identify potential areas of concern.

FIG. 3B depicts a visualization graph 300B which visualizes the same type of telemetry data log visualized in FIG. 3A, but over a different time period. Thus, the visualization graph 300B displays a spectral ellipsoid 330 that depicts strength of connections between the terms in a telemetry data log for the same type of telemetry data visualized by the spectral ellipsoid 310. A quick comparison of the visualization graphs 300A and 300B can then indicate that there are some differences between the visualization graphs 300A and 300B. For example, the portion 340 of the visualization graph 300B depicts two connecting lines between two terms on the left side of the visualization graph that are missing from the visualization graph 300A.

Because the visualization graphs depict large scale analysis of telemetry data logs, visualization graphs generated for the same type of telemetry data logs over different time periods should present an overall consistent image. That is because at a high level, telemetry data logs for the same service and/or software application should behave consistently over different time periods. As a result, differences in visualization graphs generated for the same type of telemetry data but over different periods can be indicative of errors, failures or other types of problems with the service and/or software application. Thus, a user reviewing and analyzing the visualization graphs may be able to quick identify potential problems in the service and/or software application by simply comparing two visualization graphs. For example, the user reviewing the visualization graph 300B may identify the portion 340 of the visualization graph 300B to zoom into the visualization graph 300B or enable display of the actual terms on the visualization graph 300B to identify the terms that resulted in the new connections. The strength of the new connections (e.g., the color of the lines) may also be taken into account to determine if the new connections are indicative of an error or failure that should be further analyzed.

In some cases, the differences between the visualization graphs generated from the same type of telemetry data logs but for different time periods are more pronounced and may thus more clearly identify anomalies. FIG. 3C depicts such a visualization graph which visualizes the same type of telemetry data log visualized in FIGS. 3A and 3B, but over a different time period. A quick look at the visualization graph 300C can tell a user that the data is very different from the data visualized in the visualization graphs 300A and 300C. For example, there are many more lines in the central and right regions of the visualization graph 300C than there are in both of the visualization graphs 300A and 300C. This can quickly notify the user that something about the underlying data log is different. The user may then be able to initiate an investigation to identify the source of the issue.

In this manner, large scale telemetry data can be visualized in a simple and easily understandable way that enables quick comparison and identification of fluctuations in the log representations. These fluctuations may help users detect anomalies quickly and efficiently. A user may be able to utilize a user portal to choose the length of time over which the telemetry logs are collected (e.g., logs for one-hour increments, 4-hour increments, 24-hour increments, etc.), the frequency of visualization (e.g., every 6 hours, 3 times a week, etc.), and/or the minimum number of times pairs of words should appear together before their connection is visualized on the graph. Once these parameters are specified, the data processing system may quickly process the data logs to generate the desired visualization graphs.

In addition to manual examination and review of the visualization graphs, one or more machine-learning (ML) models may be trained and utilized to analyze the visualization graphs for detection of specific types of events. For example, a dataset of visualization graphs and corresponding events (e.g., software failures, errors, etc.) or lack of events may be used in a supervised or unsupervised training process to train an ML to analyze visualization graphs of specific types of telemetry data and identify potential areas of concern. The ML model may be trained to automatically generate alerts based on the analysis of the visualization graphs such that a user may be notified of potential errors, failures and the like.

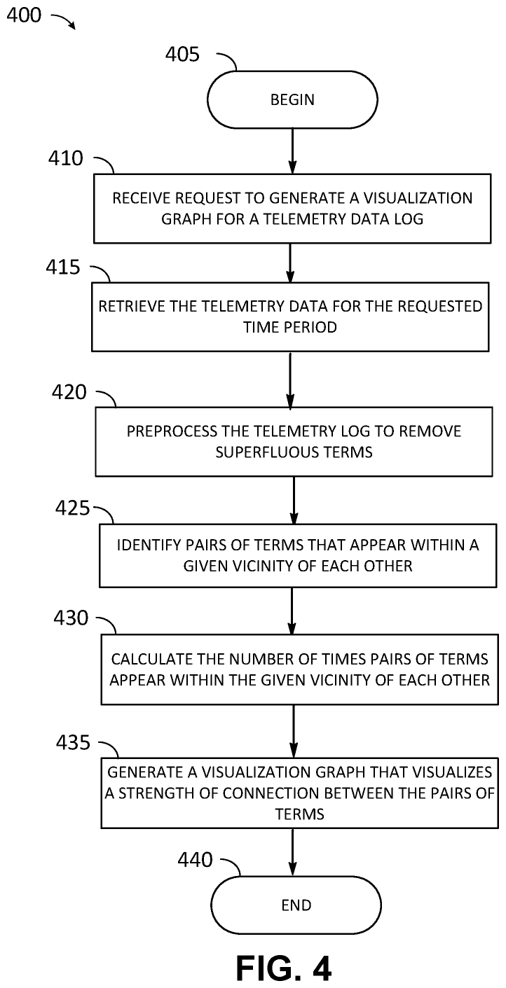

FIG. 4 is a flow diagram depicting an example method 400 for generating a visualization graph for telemetry data. One or more steps of the method 400 may be performed by a data processing engine of a telemetry data server such as the data processing engine 160 of the telemetry data server 170 of FIG. 1. The method 400 may begin, at 405, and proceed to receive a request for generating a visualization graph for a telemetry data log, at 410. In an example, the request may be received from a user via a user's client device. For example, the request may be submitted via a user portal of a service or application that offers visualization and/or analysis of telemetry data. In an example, the user portal provides options for the user to select one or more parameters for the telemetry data log. For example, the user may be able to select the type of application or service that the telemetry data is associated with. Furthermore, the user may be able to select the duration of time for which the telemetry data should be analyzed and/or a frequency (e.g., generate visualization graphs for 4-hour increments of telemetry data every 2 hours in a given 24-hour period). The user may also be able to set a minimum number of times pairs of terms in the telemetry data should appear in the vicinity of each other before they are visualized on the visualization graph.

After receiving the request, method 400 may proceed to retrieve the telemetry data for the requested time period, at 415. This may be done by retrieving the telemetry data from a telemetry data store. Once the telemetry data is retrieved, method 400 may proceed to preprocess the telemetry data by removing superfluous terms that are not likely to be indicative of any real information about the application, at 420. Superfluous terms may include stop words, numbers, non-alphabetical characters, alphabetical characters that do not form a word, and the like.

After removing unnecessary terms, method 400 may proceed to identify pairs of terms that appear within a given vicinity of each other in the telemetry data log, at 425. The given vicinity may be predetermined and may vary depending on the needs of the system or application. In an example, the predetermine vicinity is the immediate vicinity. In other words, only pairs of words that appear next to each other are identified.

Once the pairs of terms are identified, method 400 may proceed to calculate the number of times identified pairs appear within the given vicinity of each other (e.g., the number of times each identified pair of terms appear next to each other) in the telemetry data log, at 430. Once this number is calculated for all identified pairs, method 400 may proceed to generate a visualization graph that visualizes the strength of connection between the identified pairs of terms, at 435, before ending at 440. The visualization graph may be a spectral ellipsoid that represents each term as a circle along the outer perimeter of the ellipsoid and represents the strength of connection between each two pair of terms by a colored line that connects the terms. The terms may be sorted alphabetically and displayed around the perimeter of the ellipsoid in an alphabetical order.

FIG. 5 is a block diagram 500 illustrating an example software architecture 502, various portions of which may be used in conjunction with various hardware architectures herein described, which may implement any of the above-described features. FIG. 5 is a non-limiting example of a software architecture and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine depicted in block diagram 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 662, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:
Item 1. A data processing system comprising:
   a processor; and
   a memory in communication with the processor, the memory comprising executable instructions that, when executed by the processor, cause the data processing system to perform functions of:
      processing a telemetry data log to remove one or more superfluous terms from the telemetry data log;
      identifying pairs of terms in the telemetry data log that appear within a given vicinity of each other in the telemetry data log;
      for a plurality of the identified pairs of terms, calculating a number of times the pairs of terms appear within the given vicinity of each other in the telemetry data log; and
      generating a visualization graph for the telemetry data log that visualizes at least some of the plurality of the identified pairs by displaying a strength of connection between the at least some of the plurality of the identified pairs.
Item 2. The data processing system of item 1, wherein the visualization graph is a spectral ellipsoid.
Item 3. The data processing system of item 2, wherein the one or more terms from the plurality of identified pairs of terms are represented along the spectral ellipsoid.
Item 4. The data processing system of item 3, wherein a connection between the terms in the plurality of identified pairs is represented on the spectral ellipsoid by a line connecting the identified pairs.
Item 5. The data processing system of any preceding item, wherein the strength of connection is visualized by using different color connecting lines.
Item 6. The data processing system of any preceding item, wherein the given vicinity is an immediate vicinity.
Item 7. The data processing system of any preceding item, wherein the at least some of the plurality of the identified pairs are pairs of terms that appear within the given vicinity of each other more than a predetermined number of times.
Item 8. The data processing system of item 7, wherein the predetermined number of times can be selected by a user submitting a request for visualizing the telemetry data log.
Item 9. The data processing system of any preceding item, wherein the telemetry data log is a textual log of data associated with an operation of a software application.
Item 10. The data processing system of item 9, wherein a trained machine-learning model is configured to analyze the visualization graph to detect one or more events associated with the software application.
Item 11. A method for generating a visualization graph for telemetry data comprising:
   processing a telemetry data log to remove one or more superfluous terms from the telemetry data log;
   identifying pairs of terms in the telemetry data log that appear within a given vicinity of each other in the telemetry data log;
   for a plurality of the identified pairs of terms, calculating a number of times the pairs of terms appear within the given vicinity of each other in the telemetry data log; and
   generating a visualization graph for the telemetry data log that visualizes at least some of the plurality of the identified pairs by displaying a strength of connection between the at least some of the plurality of the identified pairs.
Item 12. The method of item 11, wherein the visualization graph displays a radial diagram.
Item 13. The method of item 12, wherein the one or more terms from the plurality of identified pairs of terms are represented along the radial diagram.
Item 14. The method of item 13, wherein a connection between the terms in the plurality of identified pairs is represented on the radial diagram by a line connecting the identified pairs.
Item 15. The method of item 13, wherein the strength of connection is visualized by using different color connecting lines.
Item 16. The method of any of items 11-15, wherein the at least some of the plurality of the identified pairs are pairs of terms that appear within the given vicinity of each other more than a predetermined number of times.
Item 17. A non-transitory computer readable medium on which are stored instructions that, when executed, cause a programmable device to perform functions of:
processing a telemetry data log to remove one or more superfluous terms from the telemetry data log;
identifying pairs of terms in the telemetry data log that appear within a given vicinity of each other in the telemetry data log;
for a plurality of the identified pairs of terms, calculating a number of times the pairs of terms appear within the given vicinity of each other in the telemetry data log; and
generating a visualization graph for the telemetry data log that visualizes at least some of the plurality of the identified pairs by displaying a strength of connection between the at least some of the plurality of the identified pairs.
Item 18. The non-transitory computer readable medium of item 17, wherein the visualization graph is a spectral ellipsoid and the one or more terms from the plurality of identified pairs of terms are represented along the spectral ellipsoid.
Item 19. The non-transitory computer readable medium of item 18, wherein a connection between the terms in the plurality of identified pairs is represented on the spectral ellipsoid by a line connecting the identified pairs.
Item 20. The non-transitory computer readable medium of any of items 17-19, wherein the telemetry data log is a textual log of data associated with an operation of a software application.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor, cause the data processing system to perform functions of:
processing a telemetry data log to remove one or more superfluous terms from the telemetry data log;
identifying pairs of terms in the telemetry data log that appear within a given vicinity of each other in the telemetry data log;
for a plurality of the identified pairs of terms, calculating a number of times the pairs of terms appear within the given vicinity of each other in the telemetry data log; and
generating a visualization graph for the telemetry data log that visualizes at least some of the plurality of the identified pairs by displaying a strength of connection between the at least some of the plurality of the identified pairs.

2. The data processing system of claim 1, wherein the visualization graph is a spectral ellipsoid.

3. The data processing system of claim 2, wherein the one or more terms from the plurality of identified pairs of terms are represented along the spectral ellipsoid.

4. The data processing system of claim 3, wherein a connection between the terms in the plurality of identified pairs is represented on the spectral ellipsoid by a line connecting the identified pairs.

5. The data processing system of claim 1, wherein the strength of connection is visualized by using different color connecting lines.

6. The data processing system of claim 1, wherein the given vicinity is an immediate vicinity.

7. The data processing system of claim 1, wherein the at least some of the plurality of the identified pairs are pairs of terms that appear within the given vicinity of each other more than a predetermined number of times.

8. The data processing system of claim 7, wherein the predetermined number of times can be selected by a user submitting a request for visualizing the telemetry data log.

9. The data processing system of claim 1, wherein the telemetry data log is a textual log of data associated with an operation of a software application.

10. The data processing system of claim 9, wherein a trained machine-learning model is configured to analyze the visualization graph to detect one or more events associated with the software application.

11. A method for generating a visualization graph for telemetry data comprising:
processing a telemetry data log to remove one or more superfluous terms from the telemetry data log;
identifying pairs of terms in the telemetry data log that appear within a given vicinity of each other in the telemetry data log;
for a plurality of the identified pairs of terms, calculating a number of times the pairs of terms appear within the given vicinity of each other in the telemetry data log; and
generating a visualization graph for the telemetry data log that visualizes at least some of the plurality of the identified pairs by displaying a strength of connection between the at least some of the plurality of the identified pairs.

12. The method of claim 11, wherein the visualization graph displays a radial diagram.

13. The method of claim 12, wherein the one or more terms from the plurality of identified pairs of terms are represented along the radial diagram.

14. The method of claim 13, wherein a connection between the terms in the plurality of identified pairs is represented on the radial diagram by a line connecting the identified pairs.

15. The method of claim 11, wherein the strength of connection is visualized by using different color connecting lines.

16. The method of claim 11, wherein the at least some of the plurality of the identified pairs are pairs of terms that appear within the given vicinity of each other more than a predetermined number of times.

17. A non-transitory computer readable medium on which are stored instructions that, when executed, cause a programmable device to perform functions of:
processing a telemetry data log to remove one or more superfluous terms from the telemetry data log;
identifying pairs of terms in the telemetry data log that appear within a given vicinity of each other in the telemetry data log;
for a plurality of the identified pairs of terms, calculating a number of times the pairs of terms appear within the given vicinity of each other in the telemetry data log; and
generating a visualization graph for the telemetry data log that visualizes at least some of the plurality of the identified pairs by displaying a strength of connection between the at least some of the plurality of the identified pairs.

18. The non-transitory computer readable medium of claim 17, wherein the visualization graph is a spectral ellipsoid and the one or more terms from the plurality of identified pairs of terms are represented along the spectral ellipsoid.

19. The non-transitory computer readable medium of claim 18, wherein a connection between the terms in the plurality of identified pairs is represented on the spectral ellipsoid by a line connecting the identified pairs.

20. The non-transitory computer readable medium of claim 17, wherein the telemetry data log is a textual log of data associated with an operation of a software application.
